(19) United States
(12) Patent Application Publication
(10) Pub. No.: US 2015/0309269 A1
(43) Pub. Date: Oct. 29, 2015

(54) OPTICAL MODULE

(71) Applicants: FUJITSU COMPONENT LIMITED, Tokyo (JP); FUJITSU LIMITED, Kawasaki-shi (JP)

(72) Inventors: Osamu DAIKUHARA, Tokyo (JP); Toshihiro KUSAGAYA, Tokyo (JP); Takatoshi YAGISAWA, Kawasaki (JP); Takuya UCHIYAMA, Tokyo (JP)

(73) Assignees: FUJITSU COMPONENT LIMITED, Tokyo (JP); FUJITSU LIMITED, Kawasaki-shi (JP)

(21) Appl. No.: 14/331,679

(22) Filed: Jul. 15, 2014

(30) Foreign Application Priority Data
Jul. 18, 2013 (JP) 2013-149801

(51) Int. Cl. G02B 6/42

(52) U.S. Cl. CPC G02B 6/428; G02B 6/4278

(57) ABSTRACT

An optical module includes a first circuit board comprising a wiring pattern that transmits an electric signal, a second circuit board on which a photonic device is mounted, the photonic device performing conversion between the electric signal and light, an electrical connector that electrically connects the wiring pattern to the second circuit board, and an optical waveguide that is provided on a bottom surface side of the second circuit board and guides the light output from the photonic device or the light entering the photonic device, wherein, in the longitudinal direction of the first circuit board, a length of the wiring pattern starting from one end of the first circuit board and ending at the electrical connector is smaller than a length from the electrical connector to another end of the first circuit board.

### CROSS-REFERENCE TO RELATED APPLICATION

This application is based upon and claims the benefit of priority of the prior Japanese Patent Application No. 2013-149801, filed on Jul. 18, 2013, the entire contents of which are incorporated herein by reference.

### FIELD

The embodiments discussed herein are related to an optical module.

### BACKGROUND

Recent years have seen increasing demands for high-speed signal transmissions in the field of, for example, supercomputers, servers, and data centers. For example, in the InfiniBand Trade Association (IBTA), discussions have been made on the enhanced data rate (EDR) for using high-speed signals of 26 gigabits per second (Gbps) per channel. In the Institute of Electrical and Electronics Engineers (IEEE), discussions have been made on the 100 GBASE-SR4 specification for using high-speed signals of 25.8 gigabits per second (Gbps) per channel. These have increased use of optical communications that can support high-speed signal transmissions with longer transmission distances.

In optical signal connection among devices, optical modules are commonly used to perform conversions between an electrical signal and light. In the front panel of a server, for example, an optical module is used in a connection between an optical cable and a server blade. The optical module converts the light received from the optical cable into an electric signal, and outputs the electric signal to the server blade. The optical module also converts an electric signal received from the server blade into light, and outputs the light to the optical cable.

In the housing of an optical module, a “photoelectric transducer” for performing conversions between an electric signal and light is provided. A photoelectric transducer includes a photoemitter, a driver integrated circuit (IC) for driving the photoemitter, a photoreceiver, and a trans-impedance amplifier (TIA) for converting a current received from the photoreceiver into a voltage. A related-art example is disclosed in Japanese Laid-open Patent Publication No. 2012-068539.

To increase the number of optical modules mounted on the front panel, each of the optical modules has a shape of a longitudinally long pluggable optical module. In the longitudinally long pluggable optical module, one longitudinal end of a board, that is, a card edge of a printed board is inserted into an electrical connector on the server blade, and the other longitudinal end is connected to an optical fiber. The photoelectric transducer is generally located close to the optical fiber. This increases the distance between the card edge of the printed board and the photoelectric transducer in the pluggable optical module, or in other words, lengthens the transmission path of the electric signal.

Next-generation optical modules process the electric signal at a bit rate of as high as 26 Gbps/ch, and an increasingly higher bit rate is predicted to be achieved in the future. As the transmission speed of the electric signal increases, a problem arises in the length of the transmission path of the electric signal in the optical module. Specifically, the increase in the transmission speed of the electric signal increases attenuation of the electric signal in the transmission path, and the attenuation is larger as the transmission distance is larger.

### SUMMARY

According to an aspect of an embodiment, an optical module includes a first circuit board comprising a wiring pattern that transmits an electric signal, a second circuit board on which a photonic device is mounted, the photonic device performing conversion between the electric signal and light, an electrical connector that electrically connects the wiring pattern to the second circuit board, and an optical waveguide that is provided on a bottom surface side of the second circuit board and guides the light output from the photonic device or the light entering the photonic device, wherein, in the longitudinal direction of the first circuit board, a length of the wiring pattern starting from one end of the first circuit board and ending at the electrical connector is smaller than a length from the electrical connector to another end of the first circuit board.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are schematics illustrating an internal structure of an optical module according to a first embodiment of the present invention;

FIGS. 2A and 2B are schematics illustrating an internal structure of an optical module according to a second embodiment of the present invention; and

FIG. 3 is a schematic (exploded view) illustrating a structure of an entire optical module according to a third embodiment of the present invention.

### DESCRIPTION OF EMBODIMENTS

Preferred embodiments of the present invention will be explained with reference to accompanying drawings. The embodiments are not intended to limit the scope of the optical module according to the present invention in any way. The same elements described in the embodiments are assigned with the same reference numerals, and redundant explanations thereof are omitted herein.

### [a] First Embodiment

Internal Structure of Optical Module

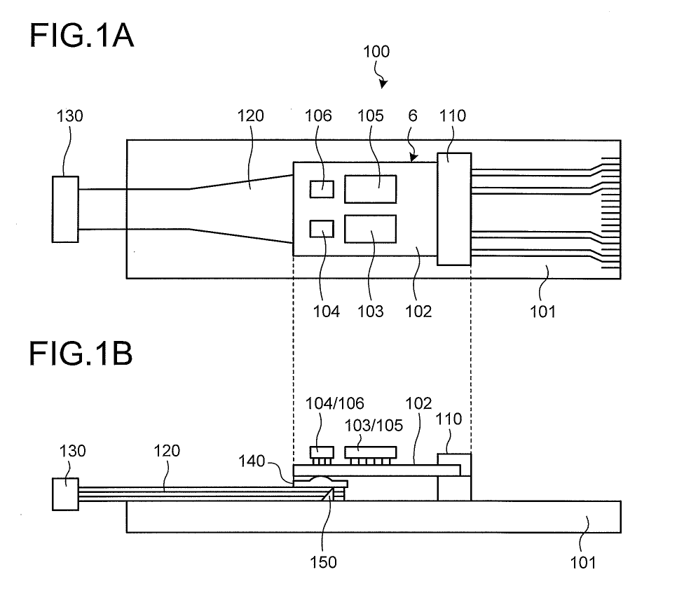

FIGS. 1A and 1B are schematics illustrating an internal structure of an optical module according to a first embodiment of the present invention. FIG. 1A is a top view, and FIG. 1B is a cross-sectional view along a direction of optical transmission.

In FIGS. 1A and 1B, this optical module 100 includes a printed board 101, an electrical connector 110, a flexible printed circuit (FPC) 102, an optical waveguide 120, and an optical connector 130. The optical module 100 includes, on the FPC 102, a driver integrated circuit (IC) 103, a photoemitter 104, a transimpedance amplifier (TIA) 105, and a photoreceiver 106.

A card edge connector is provided at one longitudinal end, specifically, at the right end in FIGS. 1A and 1B of the printed board 101. The optical module 100 is connected to a server blade via the card edge connector, and connected to an optical cable via the optical connector 130. A wiring pattern is provided between the card edge connector and the electrical connector 110 at least on the top surface of the printed board 101, and electric signals are transmitted via the wiring pattern.

A wiring pattern is provided at least on the top surface of the FPC 102, which is electrically connected to the wiring pattern provided on the printed board 101 via the electrical connector 110. A thin, transparent material, such as polyimide, causing less attenuation of electric signals at high frequencies is used as the material for the FPC 102.

The photoemitter 104 and the photoreceiver 106 that are photonic devices are mounted face-down on the top surface of the FPC 102. The photoemitter 104 converts an electric signal entering via the electrical connector 110 into light. The photoreceiver 106 converts light entering via the optical waveguide 120 into an electric signal. On the top surface of the FPC 102, the driver IC 103 for driving the photoemitter 104 is provided near the photoemitter 104, and the TIA 105 for converting a current from the photoreceiver 106 into a voltage is provided near the photoreceiver 106. The face-down mounting of the photoemitter 104 and the photoreceiver 106 can be carried out using a general electric device mounting method, such as a method using a flip-chip bonder. The photoemitter 104 is, for example, a vertical cavity surface emitting laser (VCSEL) array, and the photoreceiver 106 is, for example, a photo-diode (PD) array. The photoemitter 104, the photoreceiver 106, the driver IC 103, and the TIA 105 are mounted on the FPC 102 to provide a photoelectric transducer 6 that converts electricity to light, and light to electricity.

A lens sheet 140 is bonded on the bottom surface of the FPC 102 with an adhesion layer interposed therebetween, the lens sheet 140 being made of a transparent material and partially provided with a light-collecting lens.

The optical waveguide 120 for transmitting light is bonded on the bottom surface of the lens sheet 140. The optical waveguide 120 guides the light output from the photoemitter 104, and the light entering the photoreceiver 106. The optical waveguide 120 is a sheet-like optical waveguide, and is, for example, a polymer optical waveguide. The optical waveguide 120 is provided with a mirror 150 for bending the light path by 90 degrees and coupling the light. The optical connector 130 is provided at one end of the optical waveguide 120.

In this manner, the present embodiment uses the sheet-like optical waveguide 120, which is disposed to form layers with the photoelectric transducer 6 so that the surface of the optical waveguide 120 faces the light-receiving surface and the light-emitting surface of the photoelectric transducer 6. This can place the horizontal surface of the photoelectric transducer 6 parallel to the horizontal surface of the printed board 101, and thereby can reduce the thickness of the optical module 100.

The use of the sheet-like optical waveguide 120 can enhance the degree of freedom of the mounting position of the photoelectric transducer 6 in the longitudinal direction of the printed board 101. In other words, the photoelectric transducer 6 (and the electrical connector 110) can be placed closer to the card edge of the printed board 101 by increasing the length of the optical waveguide 120 in the longitudinal direction of the optical module 100. Consequently, the distance of the optical transmission path on the printed board 101 can be increased from a conventional distance by setting the distance between the optical connector 130 and the photoelectric transducer 6 larger than a conventional distance. This allows the length of wiring for electric signals, that is, the transmission distance of the electric signals, on the printed board 101 to be relatively smaller than a conventional distance. For example, as illustrated in FIGS. 1A and 1B, in the longitudinal direction of the printed board 101, the length of the wiring pattern starting from one end of the printed board 101 and ending at the electrical connector 110 can be set smaller than the length from the electrical connector 110 to the other end of the printed board 101. As a result, the present embodiment can reduce the attenuation of electric signals in the optical module 100.

### [b] Second Embodiment

Internal Structure of Optical Module

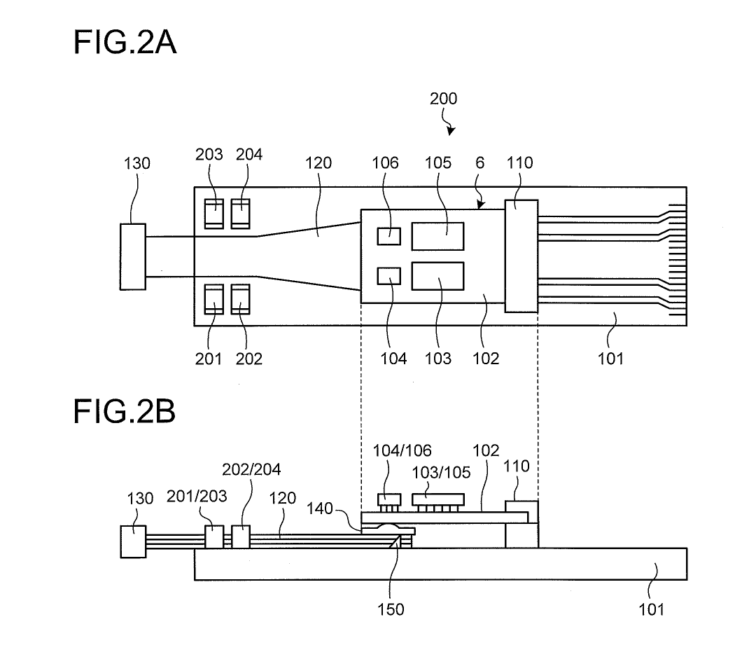

FIGS. 2A and 2B are schematics illustrating an internal structure of an optical module according to a second embodiment of the present invention. FIG. 2A is a top view, and FIG. 2B is a cross-sectional view along the direction of optical transmission.

In FIGS. 2A and 2B, this optical module 200 includes power supply circuits 201 to 204. Each of the power supply circuits 201 to 204 is a filter circuit for removing noise from power supplied from the outside of the optical module 200, or a part of a power supply circuit constituted by ICs, such as a DC-to-DC converter, and a filter circuit.

The power supply circuits 201 to 204 are disposed between the electrical connector 110 and an end on the side of the optical connector 130 of the printed board 101, in the longitudinal direction of the printed board 101. In particular, the power supply circuits 201 to 204 are preferably disposed in a position farthest from the wiring pattern that transmits electric signals, in the longitudinal direction of the printed board 101. For example, when the wiring pattern transmitting electric signals is provided between one longitudinal end of the printed board 101 and the electrical connector 110, the power supply circuits 201 to 204 are preferably disposed together at the other longitudinal end of the printed board 101.

Disposing the power supply circuits 201 to 204 on the printed board 101 in this manner can separate the wiring pattern transmitting electric signals far away from the power supply circuits 201 to 204, on the printed board 101. This can reduce the influence of the power source noise on the electric signals transmitted via the wiring pattern on the printed board 101.

### [c] Third Embodiment

Structure of Entire Optical Module

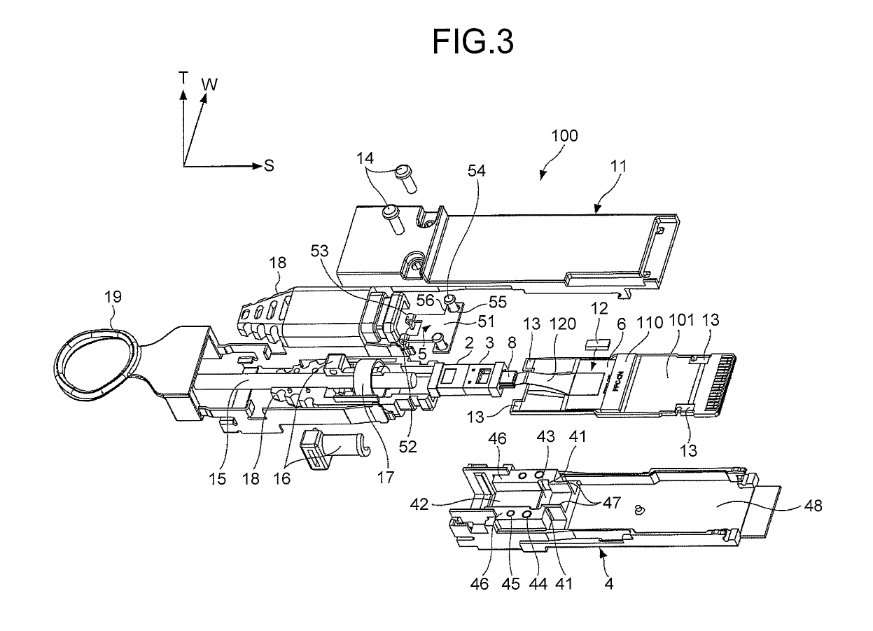

FIG. 3 is a schematic (exploded view) illustrating a structure of the entire optical module according to the third embodiment of the present invention.

As illustrated in FIG. 3, the optical module 100 includes a mechanically transferable (MT) ferrule 2, and a lens ferrule 3 aligned with the MT ferrule 2 via alignment pins. The optical module 100 also includes a lower cover 4 having a support 41 for supporting the lens ferrule 3 from the side of a connecting direction S, and a ferrule clip 5 fastened to the lower cover 4 to press the MT ferrule 2 against the lens ferrule 3. The support 41 is a wall facing the opposite direction of the connecting direction S.

In FIG. 3, “S” represents the direction in which the MT ferrule 2 is connected to the lens ferrule 3, “T” represents a thickness direction of the plate-like lower cover 4 of the optical module 100 in a direction from the bottom toward the opening, and “W” represents a width direction that is perpendicular to the connecting direction S and the thickness direction T. In the third embodiment, for the illustrative purpose, the arrow representing the thickness direction T is illustrated to point upwardly, and the arrow representing the width direction W is illustrated to point to the left with respect to the connecting direction S. Only the connecting direction S, and not the thickness direction T and the width direction W, has directionality.

The MT ferrule 2 has an almost cuboid shape, and has an extended portion extended in the width direction W and the thickness direction T on the side opposite to the connecting direction S. The lens ferrule 3 also has an almost cuboid shape, and has an extended portion extended in the width direction W and the thickness direction T on the side of the connecting direction S. The support 41 on the lower cover 4 supports the right end surface of the extended portion in the lens ferrule 3.

The ferrule clip 5 includes a plate-like portion 51 fastened to the lower cover 4, a pair of abutting portions 52 abutting against the left end surface of the MT ferrule 2, a pair of springs 53 connecting the abutting portions 52 to the plate-like portion 51 and giving a biasing force to the abutting portions 52 toward the MT ferrule 2. An example of the material of the ferrule clip 5 includes a flexible metal. The ferrule clip 5 also includes screws 54 to be tightened to the lower cover 4, and threaded holes 55 in which the screws 54 are passed. The plate-like portion 51 has a pair of tabs 56 correspondingly to the threaded holes 55.

The lower cover 4 has a U-shaped cutout 42 in which the MT ferrule 2 and the lens ferrule 3 are fitted and aligned. On the side nearer to the support 41 than the cutout 42, an enclosure 43 that accommodates the extended portion of the lens ferrule 3 is provided. The enclosure 43 is wider in the width direction W and deeper in the thickness direction T than the cutout 42. The lower cover 4 also has a block portion 46 having a pair of female screws 44 corresponding to screws 14 on an upper cover 11, and a pair of female screws 45 corresponding to the screws 54 on the ferrule clip 5, at positions outside of the cutout 42 in the width direction W. The female screws 44 are positioned nearer to the support 41 than the female screws 45. A pair of enclosure walls 47 that accommodates a ferrule boot 8 therebetween is provided nearer to the connecting direction S than the support 41. The lens ferrule 3 and the ferrule boot 8 correspond to the optical connector 130.

The optical module 100 includes an optical waveguide 120 extending from the lens ferrule 3 toward a photoelectric transducer 6, and a ferrule boot 8 for keeping the optical waveguide 120 bent. Because the ferrule boot 8 is positioned at a shorter distance to the photoelectric transducer 6 than the length of the optical waveguide 120, the optical waveguide 120 is kept bent.

The optical module 100 also includes a printed board 101, and an electrical connector 110 implemented at a predetermined position on the printed board 101, and the photoelectric transducer 6 is connected to the electrical connector 110 on the printed board 101. A card edge connector is implemented on the right edge of the printed board 101.

The optical module 100 includes the upper cover 11 for covering the opening of the lower cover 4, and a thermal conducting sheet 12 for conducting the heat produced by the photoelectric transducer 6 to the upper cover 11 to release the heat.

On the printed board 101, the area covering from where the electrical connector 110 is implemented to where the card edge connector is placed is wider than the area where the photoelectric transducer 6 is implemented in the width direction W. The printed board 101 is housed in a board enclosure 48 positioned nearer to the connecting direction S than the enclosure walls 47 of the lower cover 4.

An optical cable 15 extends from the MT ferrule 2, on the side opposite to the connecting direction S. The optical cable 15 is passed through a pair of sleeves 16 and a fastening ring 17, and fitted in a pair of cable boots 18. A pull-tab/latch 19 is attached to the cable boot 18.

To fill the gap between the printed board 101 and the upper cover 11, synthetic resin members 13 are positioned at predetermined positions on the printed board 101.

An IC, such as a retimer that shapes waveforms of high-speed signals, may be provided in the high-speed signal transmission path between the card edge connector at the right end of the printed board 101 and the electrical connector 110.

According to one aspect of the present disclosure, attenuation of electric signals in an optical module can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical module comprising:
a first circuit board comprising a wiring pattern that transmits an electric signal;
a second circuit board on which a photonic device is mounted, the photonic device performing conversion between the electric signal and light;
an electrical connector that electrically connects the wiring pattern to the second circuit board; and
an optical waveguide that is provided on a bottom surface side of the second circuit board and guides the light output from the photonic device or the light entering the photonic device, wherein
in the longitudinal direction of the first circuit board, a length of the wiring pattern starting from one end of the first circuit board and ending at the electrical connector is smaller than a length from the electrical connector to another end of the first circuit board.

2. The optical module according to claim 1, further comprising a power supply circuit between the electrical connector and the other end of the first circuit board.
